(19) United States
(12) Patent Application Publication
(10) Pub. No.: US 2011/0037862 A1
(43) Pub. Date: Feb. 17, 2011

(54) ADJUSTMENT SYSTEM AND METHOD FOR CAMERA

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/580,272

(22) Filed: Oct. 16, 2009

(30) Foreign Application Priority Data
Aug. 14, 2009 (CN) 200910305637.0

(51) Int. Cl. H04N 5/228

(52) U.S. Cl. 348/208.6; 348/E05.031

(57) ABSTRACT

An adjustment system includes a sensor, a processing unit, and a driving unit. The sensor is mounted on an electronic device to measure changes in position of the electronic device and output measurement results correspondingly. The processing unit receives the measurement results to obtain an angle of inclination of the electronic device relative to a datum plane correspondingly, and outputs an angle control signal according to the angle of inclination. The driving unit receives the angle control signal, and adjusts a shooting angle of a camera. The electronic device displays images captured by the camera.

### BACKGROUND

1. Technical Field

The present disclosure relates to an adjustment system and a method for cameras.

2. Description of Related Art

Conventional media players cannot customize the display of media in response to input, such as different visual angles. Many commonly used media players are non-interactive, thus reducing the level of user satisfaction.

### BRIEF DESCRIPTION OF THE DRAWINGS

FIG. 1 is a schematic block diagram of a first exemplary embodiment of an adjustment system including a storage system.

FIG. 2 is a schematic block diagram of the storage system of FIG. 1.

FIGS. 3A-3C are schematic diagrams of an electronic device in three states using the adjustment system of FIG. 1.

FIG. 4 is a schematic diagram of images captured by a camera in the states of the electronic device in FIGS. 3A-3C, respectively.

FIG. 5 is a schematic diagram of images displayed by the electronic device in FIGS. 3A-3C, respectively.

FIG. 6 is a schematic block diagram of a second exemplary embodiment of an adjustment system including a storage system.

FIG. 7 is a schematic block diagram of the storage system of FIG. 6.

FIG. 8 is a flowchart of a first embodiment of an adjustment method.

FIG. 9 is a flowchart of a second embodiment of an adjustment method.

### DETAILED DESCRIPTION

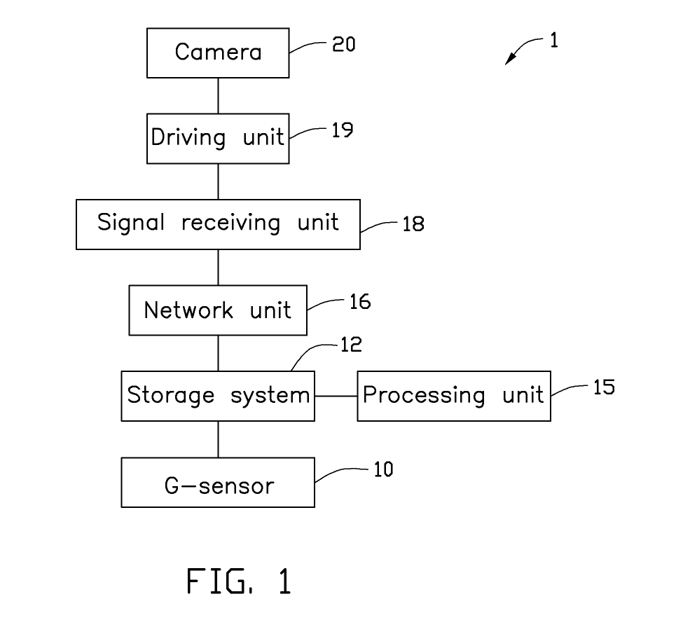

Referring to FIG. 1, a first embodiment of an adjustment system 1 includes a gravity sensor (G-sensor) 10, a storage system 12, a processing unit 15, a network unit 16, a signal receiving unit 18, and a driving unit 19. The adjustment system 1 is operable to adjust a shooting angle of a camera 20 according to the state of an electronic device. The electronic device is operable to display images captured by the camera 20.

The G-sensor 10 is mounted on the electronic device and detects motion of the device.

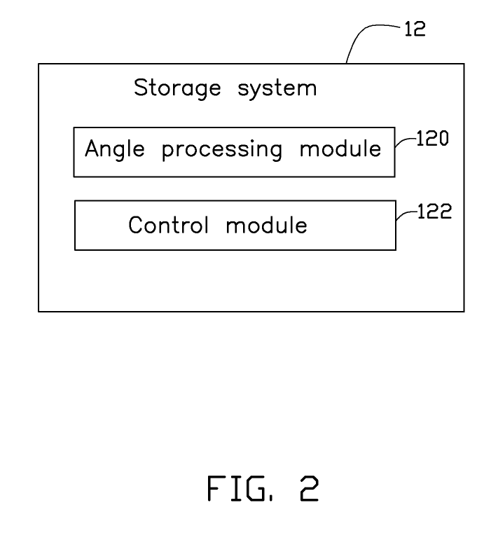

Referring to FIG. 2, the storage system 12 includes an angle processing module 120 and a control module 122. The angle processing module 120 and the control module 122 may include one or more computerized instructions and are executed by the processing unit 15.

The angle processing module 120 receives input from the G-sensor 10 and obtains an angle of inclination of the electronic device relative to a datum plane correspondingly. It can be understood that the angle processing module 120 calculates and compares voltages of the G-sensor 10 corresponding to the position of the electronic device relative to the datum plane to obtain an angle of inclination of the electronic device relative to the datum plane.

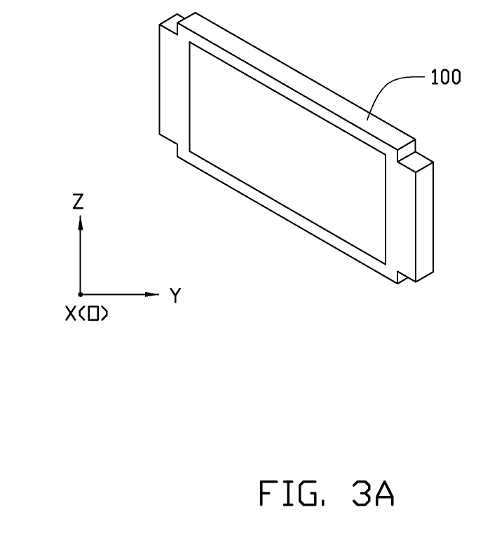

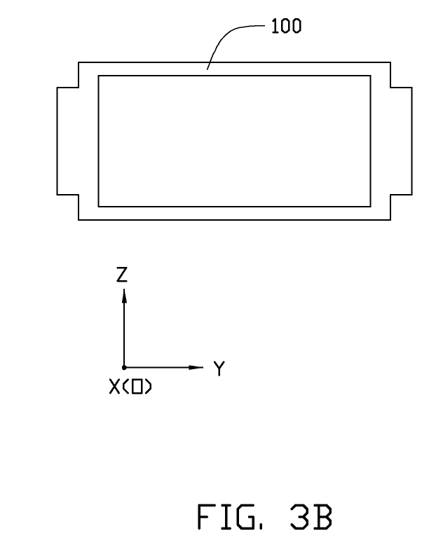

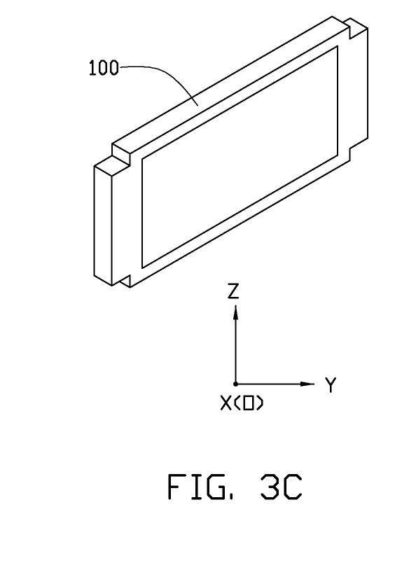

Referring to FIGS. 3A-3C, in one embodiment, the electronic device is a mobile phone 100. An angle of 135° is between the mobile phone 100 in a first state and a datum plane YOZ shown in FIG. 3A. An angle of 0° is between the mobile phone 100 in a second state and the datum plane YOZ shown in FIG. 3B. An angle of 45° is between the mobile phone 100 in a third state and the datum plane YOZ shown in FIG. 3C.

The control module 122 receives the angle of inclination of the mobile phone 100 relative to the datum plane from the angle processing module 120, and outputs an angle control signal correspondingly. For example, if the angle between the mobile phone 100 in the first state and the datum plane YOZ is 135°, the control module 122 outputs a first angle control signal. If the angle between the mobile phone 100 in the second state and the datum plane YOZ is 0°, the control module 122 outputs a second angle control signal. If the angle between the mobile phone 100 in the third state and the datum plane YOZ is 45°, the control module 122 outputs a third angle control signal.

The network unit 16 transmits the angle control signal from the control module 122 to the signal receiving unit 18. The network unit 16 may include communication tools, such as a router, to enable the storage system 12 to communicate with the signal receiving unit 18.

The signal receiving unit 18 transmits the angle control signal to the driving unit 19. It can be understood that the signal receiving unit 18 may be an interface of the driving unit 19.

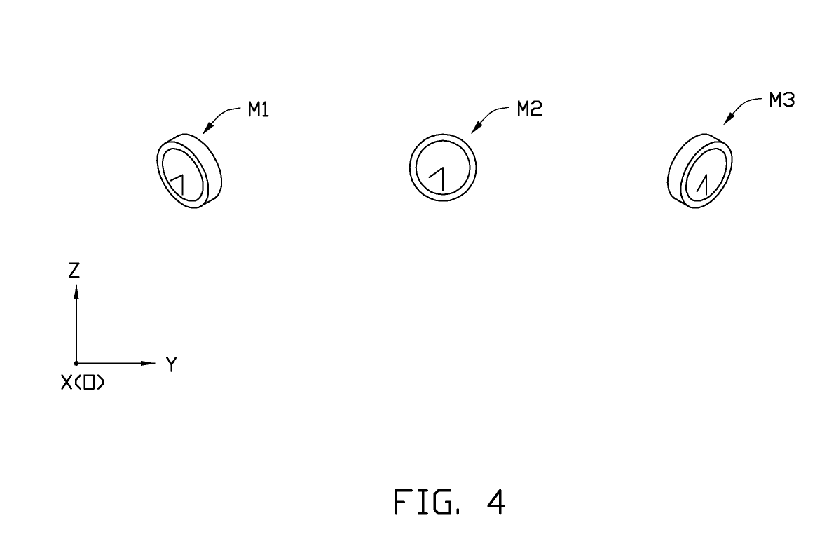

The driving unit 19 adjusts the shooting angle of the camera 20 according to the angle control signal. It can be understood that the camera 20 rotates to change the shooting angle of the camera 20. The driving unit 19 may be a pan-tilt motor. For example, if the signal receiving unit 18 receives the third angle control signal, the driving unit 19 adjusts the camera 20 to align with an object, such as an alarm clock, with a 45 degree angle left side. The camera 20 captures an image M3, as shown in FIG. 4. In a similar way, the image M1 corresponds to the mobile phone 100 in the first state. The image M2 corresponds to the mobile phone 100 in the second state.

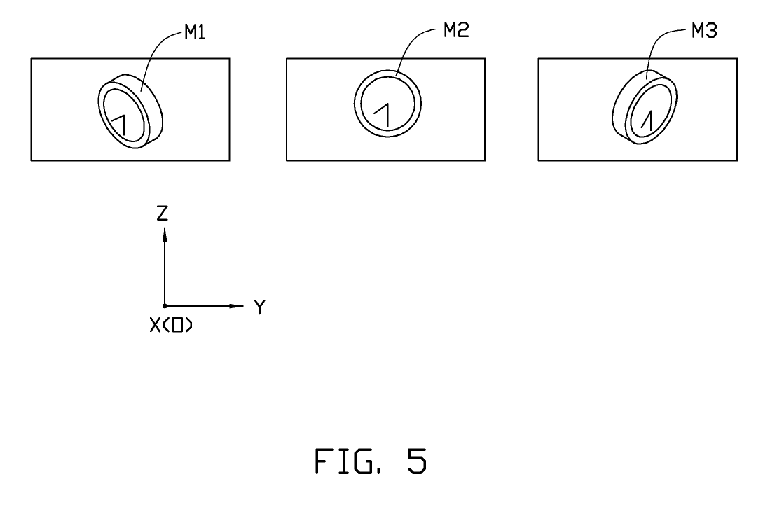

The network unit 18 transmits images captured by the camera 20 to the mobile phone 100. The mobile phone 100 displays the images as shown in FIG. 5.

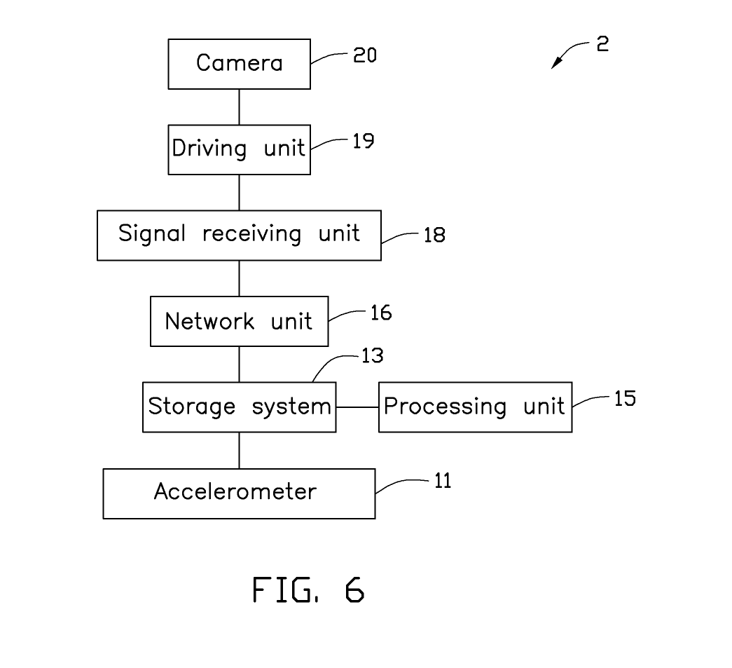

Referring to FIG. 6, a second embodiment of an adjustment system 2 includes an accelerometer 11, a storage system 13, a processing unit 15, a network unit 16, a signal receiving unit 18, and a driving unit 19.

The accelerometer 11 is mounted on the electronic device and provides measurement of detected changes in acceleration to the storage system 12.

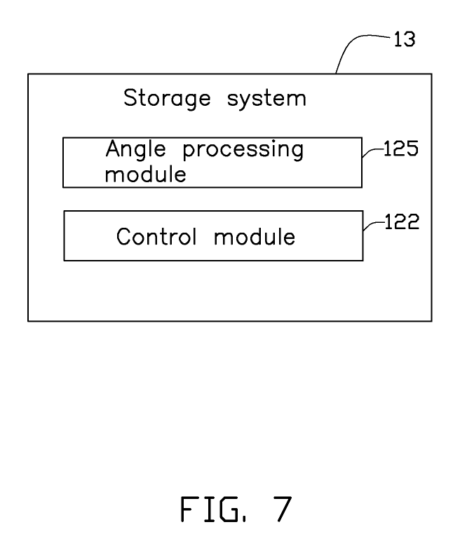

Referring to FIG. 7, the storage system 13 includes an angle processing module 125 and a control module 122. The angle processing module 125 receives input from the accelerometer 11 and uses the information to obtain an angle of inclination of the electronic device relative to a datum plane correspondingly. The control module 122 receives the angle of inclination of the mobile phone 100 relative to the datum plane from the angle processing module 125, and outputs an angle control signal correspondingly. In a similar way, the adjustment system 2 adjusts the camera 20 position correspondingly.

In other embodiments, the datum plane may be another plane or multi-planes.

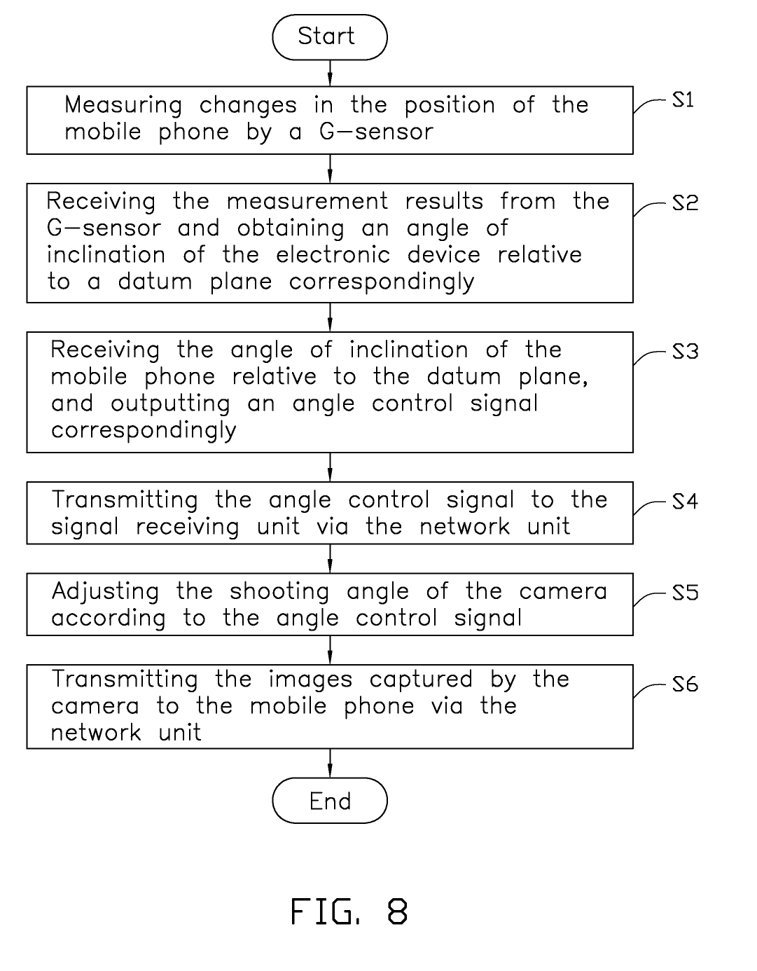

Referring to FIG. 8, a first exemplary embodiment of an adjustment method includes the following steps.

In step S1, the G-sensor 10 measures changes in the position of the mobile phone 100.

In step S2, the angle processing module 120 receives the measurement results from the G-sensor 10 and obtains an angle of inclination of the electronic device relative to a datum plane correspondingly. It can be understood that the angle processing module 120 calculates and compares measurement from the G-sensor 10 when the mobile phone 100 is parallel with the datum plane and from when the mobile phone 100 is angled relative to the datum plane to obtain the angle of inclination of the mobile phone 100 relative to the datum plane. For example, as shown in FIG. 3A, the angle between the mobile phone 100 in the first state and the datum plane YOZ is 135°. As shown in FIG. 3B, the angle between the mobile phone 100 in the second state and the datum plane YOZ is 0°. As shown in FIG. 3C, the angle between the mobile phone 100 in the third state and the datum plane YOZ is 45°.

In step S3, the control module 122 receives the angle of inclination of the mobile phone 100 relative to the datum plane from the angle processing module 120, and outputs an angle control signal correspondingly.

In step S4, the angle control signal is transmitted to the signal receiving unit 18 via the network unit 16.

In step S5, the signal receiving unit 18 transmits the angle control signal to the driving unit 19. The driving unit 19 adjusts the shooting angle of the camera 20 according to the angle control signal. It can be understood that the signal receiving unit 18 may be the interface of the driving unit 19. The driving unit 19 may be a pan-tilt motor.

In step S6, the images captured by the camera 20 are transmitted to the mobile phone 100 via the network unit 16. The mobile phone 100 displays the images.

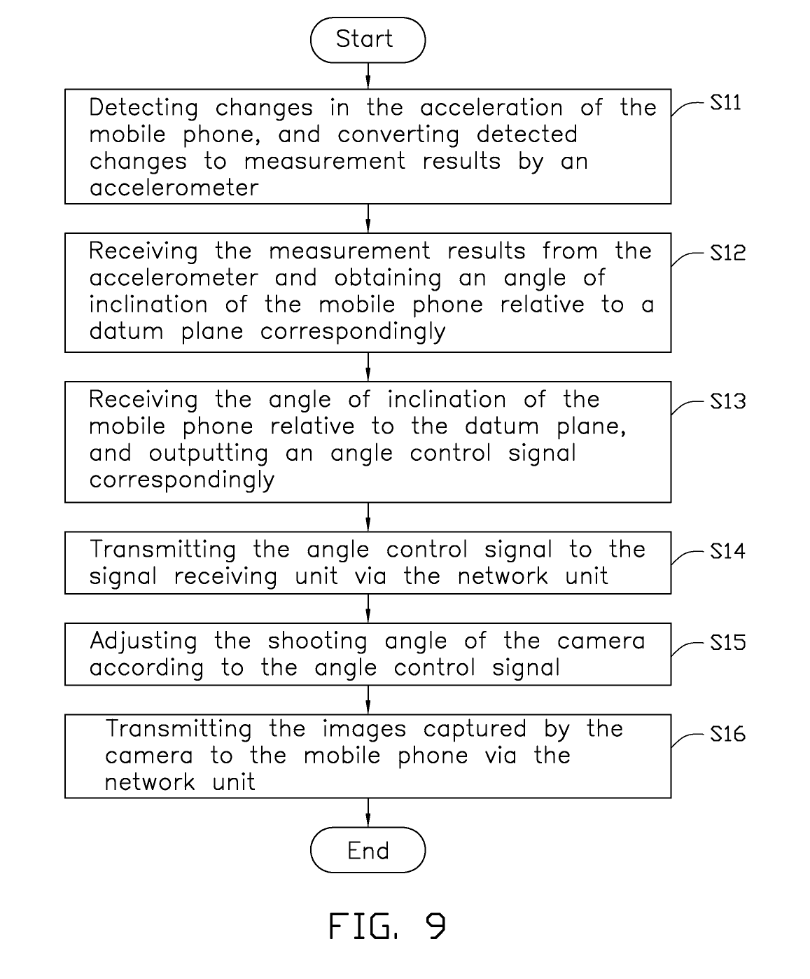

Referring to FIG. 9, a second exemplary embodiment of an adjustment method includes the following steps.

In step S11, an accelerometer 11 detects changes in the acceleration of the mobile phone 100, and converts detected changes to measurement results.

In step S12, the angle processing module 125 receives the measurement results from the accelerometer 11 and obtains an angle of inclination of the mobile phone 100 relative to a datum plane correspondingly. It can be understood that the angle processing module 125 calculates and compares voltages of the accelerometer 11 when the mobile phone 100 is parallel with the datum plane and when the mobile phone 100 is angled relative to the datum plane to obtain the angle of inclination of the mobile phone 100 relative to the datum plane.

In step S13, the control module 122 receives the angle of inclination of the mobile phone 100 relative to the datum plane from the angle processing module 125, and outputs an angle control signal correspondingly.

In step S14, the angle control signal is transmitted to the signal receiving unit 18 via the network unit 16.

In step S15, the signal receiving unit 18 transmits the angle control signal to the driving unit 19. The driving unit 19 adjusts the shooting angle of the camera 20 according to the angle control signal.

In step S16, the images captured by the camera 20 are transmitted to the mobile phone 100 via the network unit 16. The mobile phone 100 displays the images.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An adjustment system comprising:
a sensor mounted on an electronic device detecting changes in position of the electronic device and outputting measurement results correspondingly;
a processing unit;
a storage system connected to the processing unit and storing one or more modules to be executed by the processing unit, wherein the one or more modules comprise:
an angle processing module to receive the measurement results and thereby obtain an angle of inclination of the electronic device relative to a datum plane; and
a control module to receive the angle of inclination of the electronic device relative to the datum plane, and output an angle control signal correspondingly; and
a driving unit to receive the angle control signal, and adjust a shooting angle of a camera, wherein the electronic device is operable to display images captured by the camera.

2. The adjustment system of claim 1, further comprising a signal receiving unit, wherein the driving unit receives the angle control signal via the signal receiving unit.

3. The adjustment system of claim 1, further comprising a network unit, wherein the driving unit receives the angle control signal via the network unit.

4. The adjustment system of claim 1, wherein the driving unit is a pan-tilt motor.

5. An adjustment system comprising:
an accelerometer mounted on an electronic device to measure changes in acceleration of the electronic device and output measurement results correspondingly;
a processing unit;
a storage system connected to the processing unit and storing one or more modules to be executed by the processing unit, wherein the one or more modules comprise:
an angle processing module to receive the measurement results and obtain an angle of inclination of the electronic device relative to a datum plane; and
a control module to receive the angle of inclination of the electronic device relative to the datum plane, and output an angle control signal correspondingly; and
a driving unit to receive the angle control signal, and adjust a shooting angle of a camera, wherein the electronic device is operable to display images captured by the camera.

6. The adjustment system of claim 5, further comprising a signal receiving unit, wherein the driving unit receives the angle control signal via the signal receiving unit.

7. The adjustment system of claim 5, further comprising a network unit, wherein the driving unit receives the angle control signal via the network unit.

8. The adjustment system of claim 5, wherein the driving unit is a pan-tilt motor.

9. An adjustment method comprising:
measuring changes in position of an electronic device by a sensor, and converting the changes to measurement results;
processing the measurement results from the sensor to obtain an angle of inclination of the electronic device relative to a datum plane;
outputting an angle control signal according to the angle of inclination of the electronic device relative to the datum plane;
adjusting a shooting angle of a camera according to the angle control signal; and
displaying images captured by the camera by the electronic device.

10. The adjustment method of claim 9, wherein the driving unit is a pan-tilt motor.
